(19) United States
(12) Patent Application Publication
(10) Pub. No.: US 2016/0043946 A1
(43) Pub. Date: Feb. 11, 2016

(54) SYSTEMS AND METHODS FOR AGGREGATING MULTI-USER MEDIA ACCESS CONTROL PROTOCOL DATA UNIT FRAMES IN A WIRELESS NETWORK

(71) Applicant: QUALCOMM Incorporated, San Diego, CA (US)

(72) Inventors: Simone Merlin, San Diego, CA (US); George Cherian, San Diego, CA (US); Santosh Paul Abraham, San Diego, CA (US)

(21) Appl. No.: 14/813,653

(22) Filed: Jul. 30, 2015

Related U.S. Application Data
(60) Provisional application No. 62/033,971, filed on Aug. 6, 2014.

(51) Int. Cl. H04L 12/741; H04L 29/12; H04L 29/06

(52) U.S. Cl. CPC H04L 45/74; H04L 69/22; H04L 61/6022

(57) ABSTRACT

Systems, methods, and apparatuses for aggregating multi-user media access control protocol data units (MPDU) frame in a wireless network are provided. One aspect of this disclosure provides a method of wireless communication. The method includes generating, by an apparatus, an aggregated media access control protocol data unit (A-MPDU) frame comprising a plurality of media access control protocol data unit (MPDU) frames. A first MPDU frame of the plurality of MPDU frames is intended for at least a first device of a first type and a second MPDU frame of the plurality of MPDU frames is intended for at least a second device of a second type. The method further comprises inserting a value that is not defined for the second device into a media access control (MAC) header field of the first MPDU frame intended for the first device or the second MPDU frame intended for the second device.

### CLAIM OF PRIORITY UNDER 35 U.S.C. §119

The present Application for Patent claims priority to Provisional Application No. 62/033,971 entitled “SYSTEMS AND METHODS FOR AGGREGATING MULTI-USER MEDIA ACCESS CONTROL PROTOCOL DATA UNITS IN A WIRELESS NETWORK” filed Aug. 6, 2014, and assigned to the assignee hereof. Provisional Application No. 62/033,971 is hereby expressly incorporated by reference herein.

### FIELD

The present application relates generally to wireless communications, and more specifically to systems, methods, and devices for aggregating multi-user media access control protocol data unit (MPDU) frames in a wireless network.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN).

As wireless communications continue to advance, communication schemes continue to grow more complicated, prompting the aggregation of multiple message protocol data unit (MPDU) frames into a single physical layer data unit (PPDU). However, in conventional communication networks, associated wireless devices may be programmed to expect that all frames (e.g., MPDU frames) within a particular PPDU are addressed to the same recipient wireless device. For this reason, such conventional wireless devices may discontinue processing any PPDU if a first-occurring MPDU frame within the PPDU is not addressed to the particular recipient wireless device. This may result in a loss of data addressed to the particular recipient wireless device. Thus, systems, methods, and devices for aggregating multi-user media access control protocol data unit (MPDU) frames in a wireless network are desired.

### SUMMARY

One aspect of the present application provides a method for wireless communication. The method comprises generating, by an apparatus, an aggregated media access control protocol data unit (A-MPDU) frame comprising a plurality of media access control protocol data unit (MPDU) frames. A first MPDU frame of the plurality of MPDU frames is intended for at least a first device of a first type and a second MPDU frame of the plurality of MPDU frames is intended for at least a second device of a second type. The method comprises inserting a value that is not defined for the second device into a media access control (MAC) header field of the first MPDU frame intended for the first device or the second MPDU frame intended for the second device.

Another aspect of the present application provides an apparatus for wireless communication. The apparatus comprises a processor configured to generate an aggregated media access control protocol data unit (A-MPDU) frame comprising a plurality of media access control protocol data unit (MPDU) frames. A first MPDU frame of the plurality of MPDU frames is intended for at least a first device of a first type and a second MPDU frame of the plurality of MPDU frames is intended for at least a second device of a second type. The processor is further configured to insert a value that is not defined for the second device into a media access control (MAC) header field of the first MPDU frame intended for the first device or the second MPDU frame intended for the second device. The apparatus further comprises a transmitter configured to transmit the A-MPDU frame.

Yet another aspect of the present application provides a non-transitory computer-readable medium comprising code that, when executed, causes the apparatus to generate an aggregated media access control protocol data unit (A-MPDU) frame comprising a plurality of media access control protocol data unit (MPDU) frames. A first MPDU frame of the plurality of MPDU frames is intended for at least a first device of a first type and a second MPDU frame of the plurality of MPDU frames is intended for at least a second device of a second type. The code, when executed, further cause the apparatus to insert a value that is not defined for the second device into a media access control (MAC) header field of the first MPDU frame intended for the first device or the second MPDU frame intended for the second device.

Yet another aspect of the present application provides an apparatus for wireless communication. The apparatus comprises means for generating an aggregated media access control protocol data unit (A-MPDU) frame comprising a plurality of media access control protocol data unit (MPDU) frames. A first MPDU frame of the plurality of MPDU frames is intended for at least a first device of a first type and a second MPDU frame of the plurality of MPDU frames is intended for at least a second device of a second type. The apparatus further comprises means for inserting a value that is not defined for the second device into a media access control (MAC) header field of the first MPDU frame intended for the first device or the second MPDU frame intended for the second device. The apparatus further comprises means for transmitting the A-MPDU frame.

### BRIEF DESCRIPTION OF THE DRAWINGS

FIG. 1 illustrates a wireless communication system in which aspects of the present disclosure may be employed.

FIG. 2 illustrates various components that may be utilized in a wireless device that may be employed within the wireless communication system of FIG. 1,

FIG. 3 illustrates a physical layer data unit including an aggregated media access control protocol data unit (A-MPDU) frame as may be transmitted in the wireless communication system of FIG. 1, in accordance with some implementations.

FIG. 4 shows a structure of an aggregated MPDU (A-MPDU) frame, in accordance with some implementations.

FIG. 5 shows a structure of an MPDU frame, in accordance with some implementations.

FIG. 6 shows a structure of a quality of service (QoS) control field, in accordance with some implementations.

FIG. 7 shows an A-MPDU frame including a plurality of MPDU frames, in accordance with some implementations.

FIG. 8 shows an A-MPDU frame including a plurality of MPDU frames, in accordance with some other implementations.

FIG. 9 shows an A-MPDU frame including a plurality of MPDU frames, in accordance with yet other implementations.

FIG. 10 shows an A-MPDU frame including a plurality of MPDU frames, in accordance with yet other implementations.

FIG. 11 is a flowchart of a method of wireless communication, in accordance with some implementations.

### DETAILED DESCRIPTION

Various aspects of the novel apparatuses and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the present application. For example, an apparatus may be implemented or a method may be practiced using any number of the aspects set forth herein. In addition, the scope of the present application is intended to cover such an apparatus or method which is practiced using other structure, functionality, or structure and functionality in addition to or other than the various aspects of the present application set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. For example, the various aspects described herein may be used as part of the IEEE 802.11ax, 801.11ac, 802.11n, 802.11g, and/or 802.11b protocols.

In some aspects, wireless signals may be transmitted according to the 802.11ax protocol using orthogonal frequency-division multiplexing (OFDM), direct-sequence spread spectrum (DSSS) communications, a combination of OFDM and DSSS communications, or other schemes. Implementations of the 802.11ax protocol may be used for sensors, metering, and smart grid networks. Advantageously, aspects of certain devices implementing the 802.11ax protocol may consume less power or provide higher communication speeds than devices implementing other wireless protocols, such as 802.11b, 802.11g, 802.11n or 802.11ac for example.

Certain of the devices described herein may further implement Multiple Input Multiple Output (MIMO) technology. This may also be implemented as part of the 802.11ax standard. A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels or streams, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices which are the components that access the wireless network. For example, there may be two types of devices: access points (“APs”) and clients (also referred to as stations, or “STAs”). In general, an AP serves as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ax) compliant wireless link to obtain general connectivity to the Internet or to other wide area networks. In some implementations an STA may also function as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement the 802.11ax standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

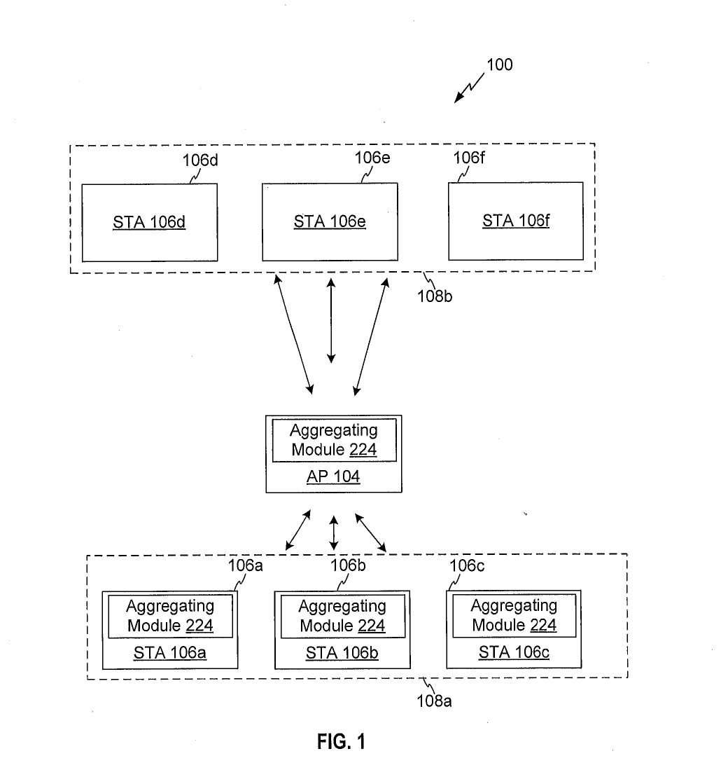

FIG. 1 illustrates an example of a wireless communication system 100 in which aspects of the present disclosure may be employed. The wireless communication system 100 may operate pursuant to a wireless standard, for example at least one of the 802.11ax, 802.11ac, 802.11n, 802.11g and 802.11b standards. The wireless communication system 100 may include an AP 104, which communicates with STAs 106a-106f.

A variety of processes and methods may be used for transmissions in the wireless communication system 100 between the AP 104 and the STAs 106a-106f. For example, signals may be transmitted and received between the AP 104 and the STAs 106a-106f in accordance with OFDM/OFDMA techniques. If this is the case, the wireless communication system 100 may be referred to as an OFDM/OFDMA system. Alternatively, signals may be transmitted and received between the AP 104 and the STAs 106a-106f in accordance with CDMA techniques. If this is the case, the wireless communication system 100 may be referred to as a CDMA system.

In FIG. 1, the STAs 106a-106c may comprise high efficiency wireless (HEW) STAs, also called “non-legacy” STAs, e.g., stations that operate according to 802.11ax communication protocols. The STAs 106a-106c may comprise an aggregating module 224, which may be configured to perform one or more actions, steps, protocols or methods as described herein The STAs 106d-106f may comprise “legacy” STAs, e.g., stations that operate according to one or more of 802.11a/b/g/n/ac communication protocols. For example, any of the non-legacy STAs 106a-106c may be configured to communicate at higher data rates, to utilize less energy during communication or operation, or to recognize additional communication protocols as compared to the legacy STAs 106d-106f. Thus, for the purposes of this disclosure, the non-legacy STAs 106a-106c may be considered part of a first group or type of STAs 108a, while the legacy STAs 106d-106f may be considered part of a second group or type of STAs 108b.

It should be noted that the wireless communication system 100 may not have a central AP 104, but rather may function as a peer-to-peer network between the STAs 106a-106f. Accordingly, the functions of the AP 104 described herein may alternatively be performed by one or more of the STAs 106a-106f.

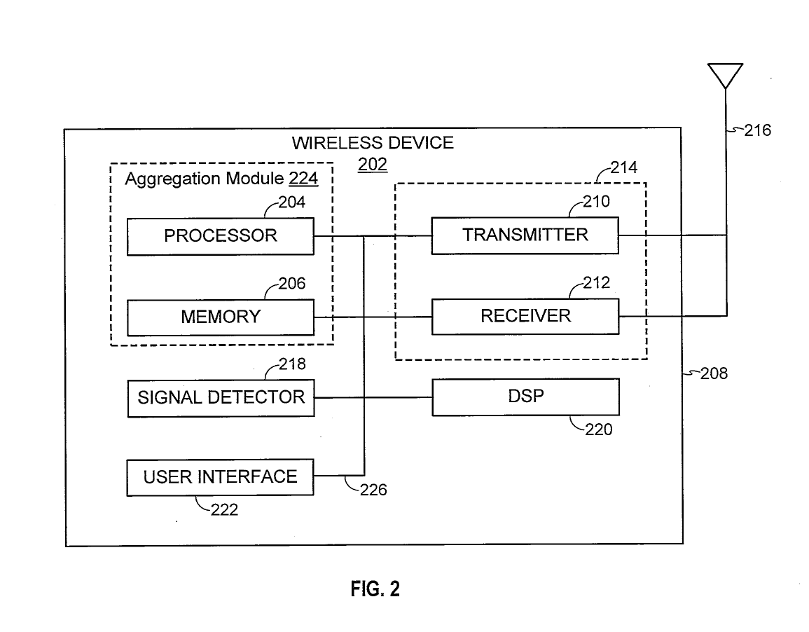

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the AP 104 or one of the STAs 106a-106f.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein. In some implementations, the wireless device 202 may include the aggregating module 224, as previously described in connection with FIG. 1, which may be configured to perform one or more actions, steps, protocols or methods as described herein. The aggregating module 224 may comprise the processor 204 and, in some implementations, the memory 206.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory, computer-readable media comprising code or software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The code, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas, which may be utilized during MIMO communications, for example.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a PPDU. In some aspects, the PPDU may be referred to as a packet. In some aspects, the PPDU may comprise an aggregated MPDU frame comprising a plurality of MPDU frames.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

As discussed above, the wireless device 202 may comprise an AP 104 or any of the non-legacy STA 106a-106c, and may be used to transmit and/or receive communications. The communications exchanged between devices in a wireless network may include data units which may comprise packets or frames. In some aspects, the data units may include data frames, control frames, and/or management frames. Data frames may be used for transmitting data from an AP and/or a STA to other APs and/or STAs. Control frames may be used together with data frames for performing various operations and for reliably delivering data (e.g., acknowledging receipt of data, polling of APs, area-clearing operations, channel acquisition, carrier-sensing maintenance functions, etc.). Management frames may be used for various supervisory functions (e.g., for joining and departing from wireless networks, etc.).

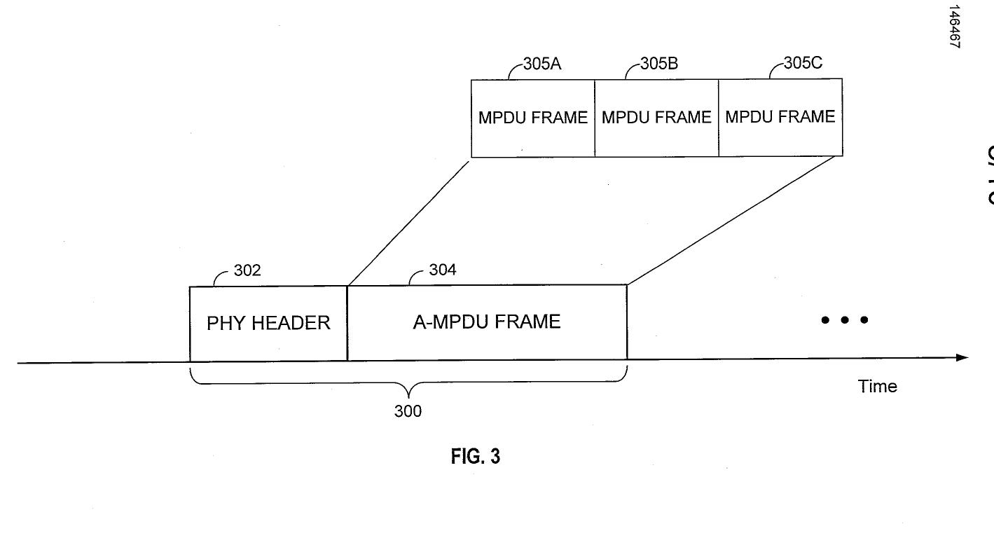

FIG. 3 illustrates a physical layer data unit 300 including an A-MPDU frame 304 as may be transmitted in the wireless communication system 100 of FIG. 1, in accordance with some implementations. As shown, time increases horizontally on the x-axis. If the AP 104 of FIG. 1 has buffered units to send to more than one of the STAs 106a-106f, instead of transmitting multiple wireless messages, the AP 104 may transmit a single A-MPDU frame 304. The A-MPDU frame 304 may include multiple MPDU frames 305A-305C. One or more of the MPDU frames 305A-305C may be addressed to a different STA than one or more of the other MPDU frames 305A-305C.

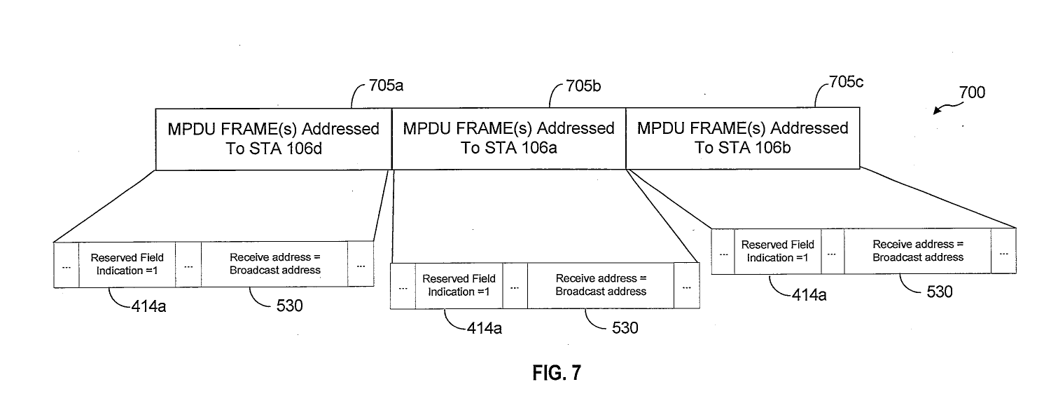

However, the 802.11a/b/g/n/ac wireless communication protocols dictate that all MPDU frames in a PPDU comprising an A-MPDU frame are addressed to the same STA. Thus, the legacy STAs 106d-106f, operating according to one or more of the 802.11a/b/g/n/ac wireless communication protocols, may discontinue processing the A-MPDU frame 304 (or transition to a power save mode) if the first MPDU frame 305A is not addressed to the particular legacy STA 106d-106f receiving the PPDU 300 even though one of the remaining MPDU frames 305B or 305C may still be addressed to the particular legacy STA. For this reason, the legacy STAs 106d-106f may not correctly process the A-MPDU frame 304 if it comprises MPDU frames addressed to more than one STA. One or more solutions to this processing problem are described in more detail below, in connection with FIGS. 7-10. In addition, the A-MPDU frame 304, having MPDU frames 305A-305C addressed to one or more of the legacy STAs 106d-106f and to one or more other of the STAs 106a-106f, may require an acknowledgement policy dictating that only one of the addressed legacy STAs 106d-106f may send an immediate response in order to avoid collisions on the network.

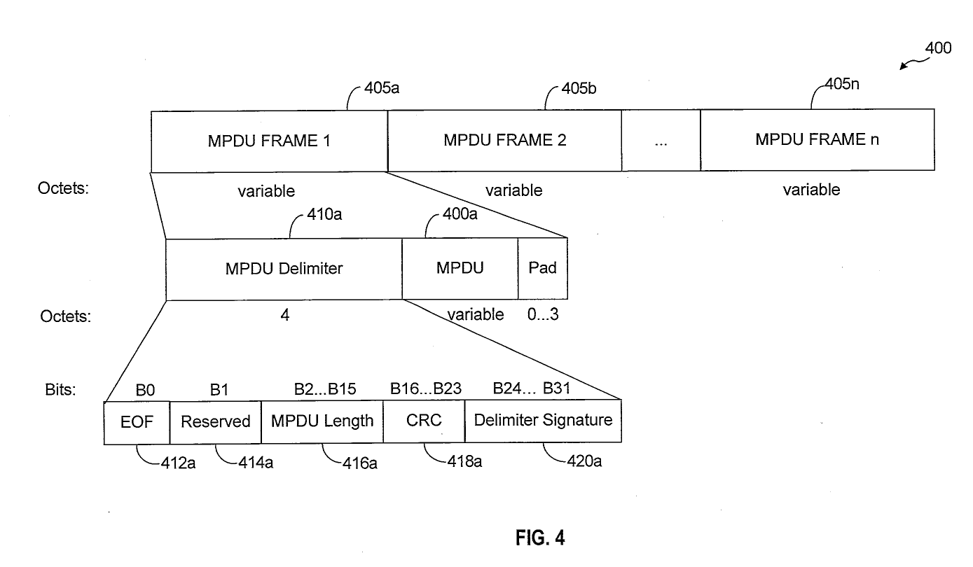

FIG. 4 shows a structure of an A-MPDU frame 400, in accordance with some implementations. As shown, the A-MPDU frame 400 includes a variable number (n) of MPDU frames, 405a, 405b, 405n. Each of the MPDU frames 405a, 405b, 405n may comprise an delimiter field 410a, an MPDU frame 400a, and zero or more pad bytes. The MPDU frames 405a-405c may conform substantially with the MPDU frames 305a-305c illustrated in FIG. 3.

Each of the delimiter fields 410a may include an end of frame (EOF) field 412a, a reserved field 414a, an MPDU frame length field 416a, a CRC field 418a, and a delimiter signature field 420a. As will be described in more detail in connection with FIG. 7, one or more bits in the reserved field 414a may be utilized to indicate to a receiving non-legacy STA 106a-106c that one or more MPDU frames within the A-MPDU frame 300, 400 (see FIGS. 3, 4 respectively) are intended for the receiving non-legacy STA 106a-106c.

In some aspects, the end of frame field 412 may be set to one (1) in the MPDU frame 405a if the MPDU frame 405a is the only MPDU frame with an MPDU frame length field 416a with a non-zero value. In some aspects, the end of frame field 412a may be set to zero (0) for each MPDU frame 405 in the A-MPDU frame 400 that has a non-zero MPDU frame length field 416a and that is not the only MPDU frame with a non-zero MPDU frame length field.

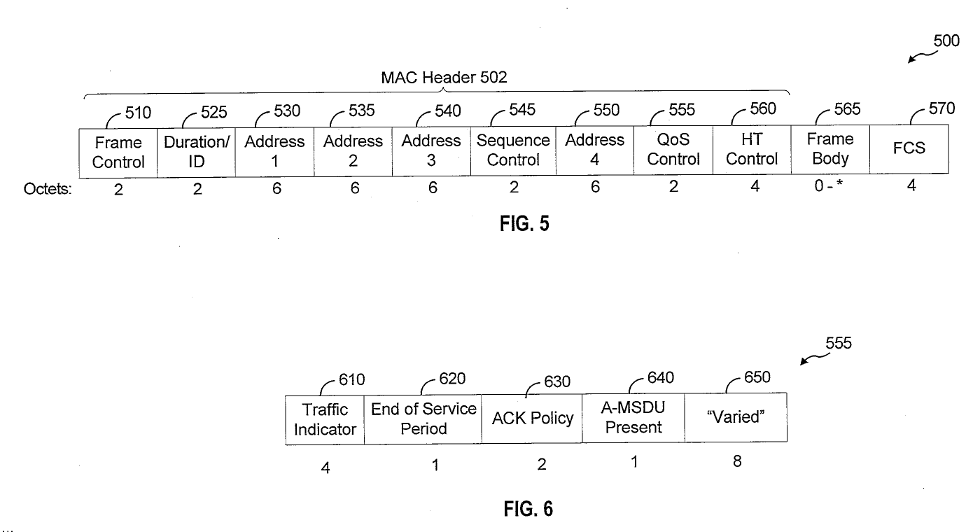

FIG. 5 shows a structure of an MPDU frame 500, in accordance with some implementations. The MPDU frame 500 may correspond to any of the MPDU frames 305A-305C or 405A-406N, as previously described in connection with FIGS. 3 and 4, respectively. As shown, the MPDU frame 500 includes 11 different fields: a frame control (fc) field 510, a duration/identification (dur) field 525, a receiver address (a1) field 530, a transmitter address (a2) field 535, a destination address (a3) field 540, a sequence control (sc) field 545, a fourth address (a4) field 550, a quality of service (QoS) control (qc) field 555, a High Throughput (HT) control field 560, a frame body 565, and a frame check sequence (FCS) field 570. Some or all of the fields 510-560 make up the MAC header 502.

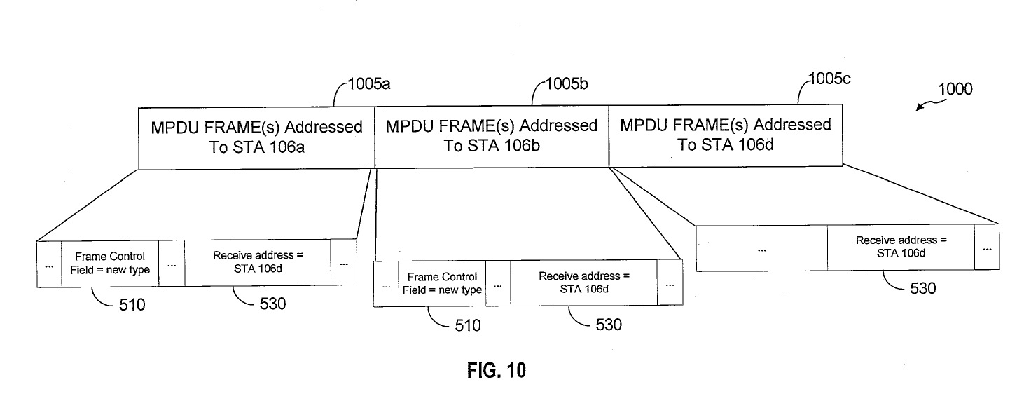

Each of the fields of the MPDU frame 500 (or values indicated in those fields) may be considered media access control parameters. Additionally, each field shown in FIG. 5 may comprise one or more fields. For example, the frame control field 510 may comprise multiple fields, such as a protocol version field, type field, subtype field, and other fields. As will be described in more detail in connection with FIG. 10, in some implementations, a type field within the frame control field 510 may be utilized to identify at least one MPDU frame within an A-MPDU frame as being addressed to or intended for an STA that communicates according to a non-legacy wireless communication protocol. Each of these fields may also be considered a media access control parameter. In some embodiments, individual bits of a media access control frame may be considered a media access control parameter.

Each of the a1, a2, a3, and a4 fields 530, 535, 540, and 550, respectively, may comprise a full MAC address of a device, which is a 48-bit (6 octet) value. In some aspects, any of these fields may comprise an AID based on a short MAC header format. As will be described in more detail in connection with FIGS. 7, 9 and 10, in some implementations, one or more of the address fields a1, a2, a3, and a4 530, 535, 540, 550 may include a particular address for identifying at least one MPDU frame within an A-MPDU frame as being addressed to or intended for an STA that communicates according to a non-legacy wireless communication protocol.

FIG. 5 further indicates the size in octets of each of the fields 510-570. The frame body field 565 comprises a variable number of octets. MPDU frames of different types may include only a portion of the fields shown in FIG. 5. For example, if a MPDU frame is a control frame, the MAC header of the MPDU frame may not include the QoS control field 555 or the HT control field 560. In addition, depending on the type, the MPDU frame 500 may include additional fields. However, in some cases, regardless of the type, the MPDU frame 500 may include the frame control field 510.

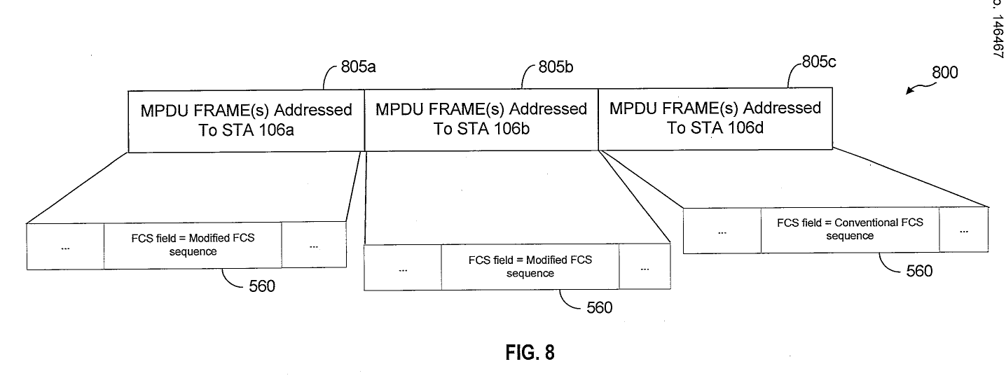

As will be described in more detail in connection with FIG. 8, in some implementations, a modified frame check sequence may be utilized in the FCS field 570 for identifying at least one MPDU frame within an A-MPDU frame as being addressed to or intended for an STA that communicates according to a non-legacy wireless communication protocol.

FIG. 6 shows a structure of a quality of service (QoS) control (qc) field 555, in accordance with some implementations. As shown, the QoS control field 555 includes five (5) different fields: a traffic indicator (TID) field 610, an end of service period field 620, an acknowledgement policy field 630, an aggregated MSDU present field 640, and a “varied” field 650. In some aspects, the acknowledgement policy field 630 may indicate one of four acknowledgment policies. In some aspects, the four acknowledgement policies may include “normal acknowledgement or implicit block acknowledgement request,” “no acknowledgement,” “no acknowledgement or power save multi-poll (PSMP) acknowledgement,” and “block acknowledgement.” In some aspects the acknowledgement policy (ACK policy) field 630 and the traffic indicator (TID) field 610 may be inserted elsewhere in the MAC header. For example, the acknowledgement policy field and/or the TID field may be inserted in the frame control field 510 of the MAC header 502, as previously described in connection with FIG. 5.

The “varied” field 650 may be a variety of different fields depending on the embodiment of the QoS Control field 555. For example, in some aspects, the “varied” field 650 may be a TXOP Limit field, an access point PS Buffer State field, a TXOP Duration Requested field, or a Queue size field.

In some aspects, if the acknowledgement policy field 630 indicates a particular value, such as “normal acknowledgement or implicit block acknowledgement request,” and the MPDU frame 500 is included as part of an A-MPDU frame, the addressed recipient of the MPDU frame may transmit an acknowledgement frame or a block acknowledgement frame, either if the MPDU frame 500 is transmitted individually or if transmitted as part of an A-MPDU frame. The transmission of the acknowledgement or block acknowledgement may begin a Short Interframe Space (sIFS) time period after receipt of the PPDU carrying the MPDU frame 500 is completed. In some aspects, if the acknowledgement policy field 630 indicates “no acknowledgement,” the addressed recipient of the MPDU frame takes no action upon receipt of the MPDU frame. In some aspects, if the acknowledgement policy field 630 indicates “block acknowledgement,” the addressed recipient of the MPDU frame takes no action upon the receipt of the frame except for recording a state. The recipient can expect a block acknowledgement request frame in the future to which it will respond.

To coordinate acknowledgements from each of the receivers, one or more of the MPDU frames may include one or more fields defining an acknowledgement policy for the MPDU frame, For example, the acknowledgement policy may indicate whether an acknowledgement for the MPDU frame should be transmitted by an addressed receiver, the type of acknowledgement that should be transmitted (e.g., whether an acknowledgement or block acknowledgement should be transmitted) and/or a delay time period between when the A-MPDU frame is received and when an acknowledgement to any MPDU frame included in the A-MPDU frame is transmitted. The indicated acknowledgement policy of each MPDU frame functions to coordinate acknowledgements of each of the MPDU frames so as to reduce the probability of collisions that may occur if each of the MPDU frames were separately acknowledged.

Accordingly, the acknowledgement policy field 630 in each of the MPDU frames 500 may be utilized to ensure that at most one legacy STA 106d-106f will send an immediate response based on receipt of the A-MPDU frame including the MPDU frames 500. Thus, if a legacy STA 106d-106f is requested to send an immediate response, no other STAs 106a-106f may send an immediate response. Likewise, if an immediate response is requested from one or more non-legacy STAs (e.g., the STAs 106a-106c configured to communicate according to at least the 802.11ax protocol) then no legacy STA (e.g., any of the STAs 106d-106f) may be requested to send an immediate response. Such requests or limitations may be affected by appropriately setting the respective ACK policy field 630 in the MPDU frames 305a-305c or 405a-405n discussed in connection with FIGS. 3 and 4, respectively. For example, if a clear to transmit (CTX) frame is aggregated with at least one other data MPDU frame, none of the at least one other data MPDU frames may require an immediate acknowledgement response to avoid collisions on the network with the ACK response to the CTX frame.

FIG. 7 shows an A-MPDU frame 700 including a plurality of MPDU frames 705a-705c, in accordance with some implementations, In FIG. 7, the A-MPDU frame 700 may comprise one or more MPDU frames intended for one or more legacy STAs 106d-106f followed by one or more MPDU frames intended for one or more non-legacy STAs 106a-106c. For the purpose of example and not limitation, the first MPDU frame 705a may be intended for the legacy STA 106d, while the second MPDU frame 705b and the third MPDU frame 705c may be intended for the non-legacy STAs 106a and 106b, respectively.

Since the non-legacy STAs 106a and 106b have MPDU frames intended for them after the first MPDU frame 705a, the non-legacy STAs 106a and 106b need to be informed of this condition to ensure the non-legacy STAs 106a and 106b continue to “listen” to the A-MPDU frame 700 after the first MPDU frame 705a has been received. However, since the A-MPDU frame 700 includes the MPDU frame 705a addressed to the legacy STA 106d, in order for the legacy STA 106d to be able to correctly process the A-MPDU frame 700, it is necessary that the A-MPDU frame 700 be sent with a PHY format that is decodable by the legacy STAs. Indications of later-occurring, non-legacy MPDU frames 705b and 705c may be included in the PHY header 302 (see FIG. 3). In certain cases, inclusion of the indication in the PHY header may compromise the legacy decodability. For this reason, such indications of later-occurring, non-legacy MPDU frames 705b and 705c may not be inserted in the PHY header.

Accordingly, one solution shown in FIG. 7 is to include a value in one or more bits of the reserved field 414a (see FIG. 4) of the MPDU frame delimited field 410a in one or more of the MPDU frames 705a-705c. The value may indicate that at least one upcoming MPDU frame 705b and 705c in the A-MPDU frame 700 is intended for a non-legacy STA 106a-106c. For example, the MPDU frame 705a, intended for the legacy STA 106d, may include the value in the reserved bit field 414a. Thus, the legacy STA 106d may receive the A-MPDU frame 700 and correctly process the MPDU frame 705a since it is intended for, or addressed to, the legacy STA 106d. In addition, since the reserved field 414a of the MPDU frame 705a includes the value, each of the non-legacy STAs 106a-106c may be configured to receive the first MPDU frame 705a, read the reserved field 414a, and determine that at least one MPDU frame 705b, 705c intended for a non-legacy STA 106a-106c is yet to be received in the A-MPDU frame 700.

Likewise, the MPDU frame 705b, intended for the non-legacy STA 106a, may include the value in its respective reserved bit field 414a. Thus, the non-legacy STA 106a may receive the A-MPDU frame 700 and also correctly process the MPDU frame 705b since it is intended for, or addressed to, the legacy STA 106a. In addition, since the reserved field 414a of the MPDU frame 705b includes the value, each of the non-legacy STAs 106a-106c may be configured to receive the second MPDU frame 705b, read the reserved field 414a, and determine that at least one MPDU frame 705c intended for the non-legacy STA 106b is yet to be received in the A-MPDU frame 700.

Since the third MPDU frame 705c, intended for the non-legacy STA 106b, is the last illustrated MPDU frame, it may include the value in its respective reserved bit field 414a, although it is not required. Thus, the non-legacy STA 106b may receive the A-MPDU frame 700 and correctly process the third MPDU frame 705c since it is intended for, or addressed to, the legacy STA 106b, and since the non-legacy STA 106b continued to receive the A-MPDU frame 700 after the first MPDU frame 705a based on the values in the reserved fields 414a of the first and second MPDU frames 705a, 705b.

In other implementations, still illustrated by FIG. 7, a receive address field 530 of the MAC header 502 (see FIG. 5) of one or more of the MPDU frames 705a-705c may include an address associated with a broadcast transmission (e.g., an association ID (AID), partial AID, or other address associated with broadcast transmission) to at least the non-legacy STAs to which at least one of the MPDU frames 705a-705c are intended. Since the non-legacy STAs 106a-106c may be configured to read and correctly process a broadcast address in the address field 530 of the MPDU frames 705a-705c in the A-MPDU frame 700, the broadcast address may provide an indication to at least the non-legacy STAs 106a, 106b that at least one MPDU frame intended for a non-legacy STA 106a-106c will be received in the A-MPDU frame 700.

However, since MPDU frames intended for legacy STAs are transmitted in the A-MPDU frame before MPDU frames intended for non-legacy STAs, the implementations shown in FIG. 7 may have several drawbacks. For example, the non-legacy STAs 106a-106c may not have enough time to perform certain required complex processing related to their received MPDU frames. Furthermore, since the non-legacy STA destined MPDU frames are always transmitted after all legacy STA destined MPDU frames, the non-legacy STAs must decode all packets in every A-MPDU frame.

FIG. 8 shows an A-MPDU frame 800 including a plurality of MPDU frames 805a-805c, in accordance with some other implementations. In FIG. 8, the A-MPDU frame 800 may comprise one or more MPDU frames 805a, 805b intended for one or more non-legacy STAs 106a-106c followed by one or more MPDU frames 805c intended for one or more legacy STAs 106d-106f. For the purpose of example and not limitation, the first MPDU frame 805a may be intended for the non-legacy STA 106a, the second MPDU frame 805b may be intended for the non-legacy STA 106b, and the third MPDU frame 805c may be intended for the legacy STA 106d.

As shown in FIG. 8, rather than utilizing a broadcast address in the receive address 530 (see FIG. 5) or a value in a reserved field 414a (see FIG. 4) of the MPDU frames, a modified frame check sequence (FCS) may be included in the FCS field 570 (e.g., in the MAC header 502 of FIG. 5) of MPDU frames of the A-MPDU frame 800 intended for non-legacy STAs. The modified FCS may be modified such that non-legacy STAs 106a-106c are able to correctly decode the FCS, while legacy STAs operating according to conventional FCS sequences, will decode the FCS as an incorrect FCS and will discard the associated MPDU frame as corrupted. Such an arrangement may allow the legacy STAs 106d-106f to continue reading the A-MPDU frame 800 even though the first and second MPDU frames 805a, 805b are not addressed to a legacy STA, since the legacy STAs 106d-106f will drop the frames having the modified FCS sequence as corrupted, rather than as addressed to another STA.

In some implementations according to FIG. 8, the checksum (e.g., the FCS) may be computed in a different manner than is done conventionally. For example, the AP may modify a value of one or more bits of a conventional FCS to generate the modified FCS sequence. In some implementations, one or more bits of the conventional FCS may be exclusive-OR'ed (XOR) with a known or predetermined pattern. In some other implementations, one or more additional bits may be added to the conventional FCS to generate the modified FCS. The non-legacy STAs 106a-106c may be aware of the modified FCS computation and may be configured to correctly decode the MPDU frames 805a, 805b accordingly. The non-legacy STAs 106a-106c may be made aware of the modified FCS computation based on an indication of a specific type or subtype of frame, as may be included in the frame control field 510 (see FIG. 5). In an alternative, the non-legacy STAs may be made aware of the modified FCS computation by inclusion of a specific address or group of addresses in one or more of the address fields 530, 535, 540, 550 (see FIG. 5). Such addresses may not necessarily correspond to addresses of the particular non-legacy devices to which one or more MPDU frames of an A-MPDU frame are addressed. Thus, the addresses may not be assigned to a particular STA but may instead indicate the use of the modified FCS sequence. In some other implementations, a particular standard (e.g., the 802.11ax) may dictate that all STAs be configured to correctly decode MPDU frames utilizing the conventional as well as the modified FCS sequence. In yet other implementations, the recipient non-legacy STAs may communicate with one another to establish a previously agreed upon modified FCS sequence or, protocol.

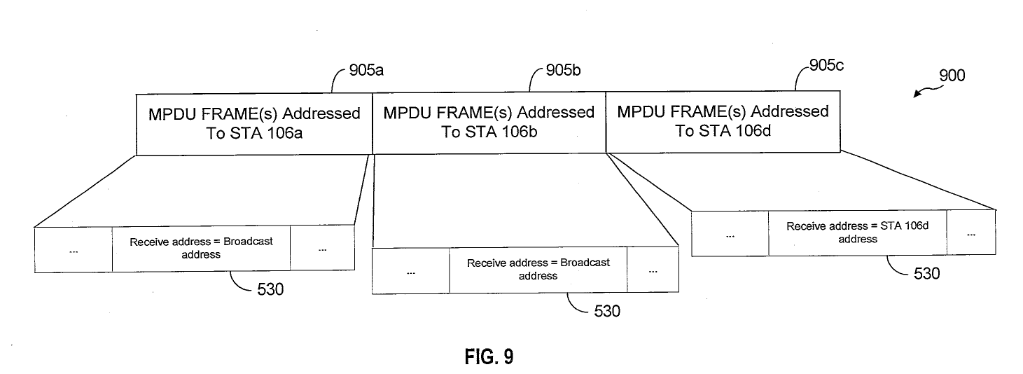

FIG. 9 shows an A-MPDU frame 900 including a plurality of MPDU frames 905a-905c, in accordance with yet other implementations. In FIG, 9, the A-MPDU frame 900 may comprise one or more MPDU frames 905a, 905b intended for one or more non-legacy STAs 106a-106c followed by one or more MPDU frames 905c intended for one or more legacy STAs 106d-106f. For the purpose of example and not limitation, the first MPDU frame 905a may be intended for the non-legacy STA 106a, the second MPDU frame 905b may be intended for the non-legacy STA 106b, and the third MPDU frame 905c may be intended for the legacy STA 106d.

As shown in FIG. 9, a receive address field 530 of the MAC header 502 (see FIG. 5) of the MPDU frames 905a, 905b that are intended for non-legacy STAs may include a broadcast address (see FIG. 7) associated with at least the non-legacy STAs to which at least one of the MPDU frames 905a-905b are intended. The non-legacy STAs 106a-106c may be configured to read and correctly process the broadcast address in the receive address field 530 of MPDU frames 905a-905c in the A-MPDU frame 900. However, the legacy STAs 106d-106f operate according to communication protocols (e.g., the 802.11a/b/n/g/ac protocols) that dictate all MPDU frames in an A-MPDU frame are to be addressed to a single destination STA. For this reason, the legacy STAs are not configured to process A-MPDU frames comprising MPDU frames having a broadcast address in the receiver address field 530 (see FIG. 5). Accordingly, upon receiving the first MPDU frame 905a and the second MPDU frame 905b, each having the broadcast address in the receiver address field 530, the legacy STAs 106d-106f may discard the first and second MPDU frames 905a and 905b as being corrupted or otherwise incorrectly received and continue processing the A-MPDU frame 900 until receiving the “valid” third MPDU frame 905c, rather than discontinuing processing the A-MPDU frame 900 after reception of the first MPDU frame 905a addressed to an STA other than the receiving legacy STA. In this way, communication of the A-MPDU frame 900 may be compatible with operation of both legacy STAs 106d-106f and non-legacy STAs 106a-106c.

FIG. 10 shows an A-MPDU frame 1000 including a plurality of MPDU frames 1005a-1005c, in accordance with yet other implementations. In FIG. 10, the A-MPDU frame 1000 may comprise one or more MPDU frames 1005a, 1005b intended for one or more non-legacy STAs 106a-106c configured to communicate according to at least the 802.11ax protocol followed by one or more MPDU frames 1005c intended for one or more legacy STAs 106d-106f configured to communicate according to at least one of the 802.11a/b/n/g/ac protocols but not the 802.11ax protocol. For the purpose of example and not limitation, the first MPDU frame 1005a may be a control or management frame intended for the non-legacy STA 106a, the second MPDU frame 1005b may be a control or management frame intended for the non-legacy STA 106b, and the third MPDU frame 1005c may be intended for the legacy STA 106d. Examples of control or management frames may include but are not limited to CTX frames or trigger frames for uplink multi-user (UL MU) transmissions.

As previously stated, the first and second MPDU frames 1005a, 1005b are intended for the non-legacy STAs 106a, 106b, respectively. However, as shown in FIG. 10, each of the first and second MPDU frames 1005a, 1005b include the destination address of the legacy device for which the third MPDU frame 1005c is intended in the receiver address field 530 (see FIG. 5). In addition, each of the first and second MPDU frames 1005a, 1005b may include a value indicating a new frame type in the frame control field 510 (see FIG. 5). The new frame type may be a frame type that non-legacy STAs 106a-106c are configured to decode and process as indicating a MPDU frame intended for a non-legacy STA. However, the new frame type may be a frame type not recognized by the legacy STAs 106d-106f.

Accordingly, upon receiving the first MPDU frame 1005a, a legacy STA 106d may read the receiver address field 530 of the first MPDU frame 1005a, decode the address associated with the STA 106d and determine that the first MPDU frame 1005a is intended for the STA 106d. However, the legacy STA 106d will also attempt to decode the frame control field 510 of the first MPDU frame 1005a. Since the value for the new frame type is not defined for the legacy STA 106d, the legacy STA 106d will discard the first MPDU frame 1005a. The legacy STA 106d will, likewise discard the second MPDU frame 1005b. However, upon decoding the third MPDU frame 1005c, the legacy STA 106d will correctly decode the value associated with the legacy STA 106d in the receive address field 530 without a value indicating the new frame type in a respective frame control field 510 and will determine that the third MPDU frame is intended or the legacy STA 106d.

By contrast, the non-legacy STAs 106a-106c will receive the first MPDU frame 1005a, read the frame control field 510 and decode the indication of the new type of frame since the value for the new type of frame is defined for non-legacy STAs. The non-legacy STAs 106a-106c are configured to decode the value of the new frame type and determine that the first MPDU frame 1005a is intended for a non-legacy STA 106a-106c. Accordingly, upon decoding and processing the value indicating the new frame type in the frame control field 510, the non-legacy STAs 106a-106c may be configured to ignore the address indicated by the receive address field 530. The non-legacy STAs may decode and process the second MPDU frame 1005b as the first MPDU frame 1005a. Finally, since the third MPDU frame 1005c does not include the value indicating the new frame type in the frame control field 510, the non-legacy STAs may determine that the third MPDU frame 1005c is addressed to a legacy device and ignore the frame. In this manner, MPDU frames for both legacy STAs and non-legacy STAs may be aggregated into the same A-MPDU frame while maintaining compatibility with both legacy STAs as well as non-legacy STAs operating according to newer, possibly more advanced communications protocols.

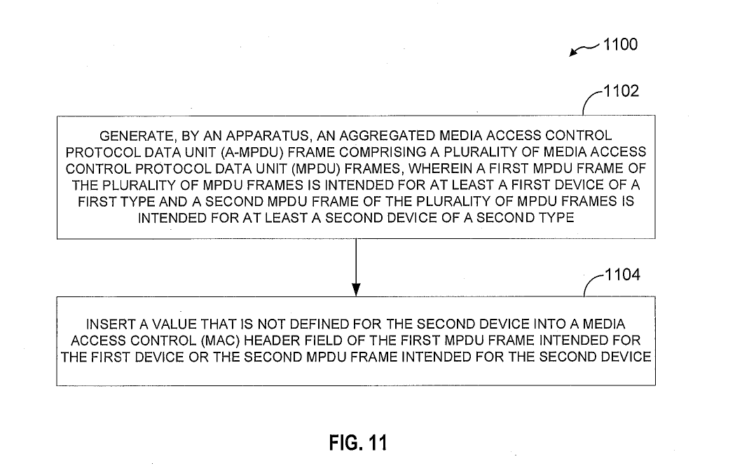

FIG. 11 is a flowchart 1100 of a method of wireless communication, in accordance with some implementations. In some aspects, the process 1100 may be performed by the AP 104, which may be shown in more detail as the wireless device 202 of FIG. 2. In some aspects, process 1100 may be performed by the AP 104. The method of flowchart 1100 may correspond to one or more implementations, as previously described in connection with FIGS. 3-10.

Block 1102 includes generating, by an apparatus, an aggregated media access control protocol data unit (A-MPDU) frame comprising a plurality of media access control protocol data unit (MPDU) frames. A first MPDU frame of the plurality of MPDU frames is intended for at least a first device of a first type and a second MPDU frame of the plurality of MPDU frames is intended for at least a second device of a second type. For example, as previously described in connection with each of FIGS. 3, 4 and 7-10, the A-MPDU frames 300, 400, 700, 800, 900, 1000 each comprise a plurality of MPDU frames 305a-305c, 405a-405c, 705a-705c, 805a-805c, 905a-905c and 1005a-1005c. As previously described, the plurality of MPDU frames are intended for one or more devices belonging to a first type of devices, e.g., the first frame intended for one or more of the non-legacy devices 106a-106c (see FIG. 1), and to a second type of devices, e.g., the legacy devices 106d-106f (see FIG. 1). The non-legacy devices 106a-106c are configured to communicate according to at least a first wireless communication protocol (e.g., the 802.11ax protocol), while the legacy devices 106d-106f are configured to communicate according to at least a second wireless protocol but not the first wireless protocol (e.g., any of the 802.11a/b/n/g/ac protocols but not the 802.11ax protocol).

In some implementations, see FIG. 7, the MPDU frames intended for one or more of the legacy devices (e.g., MPDU frame 705a addressed to the legacy STA 106d) are inserted before the MPDU frames intended for one or more of the non-legacy devices (e.g., MPDU frames 705b, 705c addressed to the non-legacy devices 106a, 106b) in the A-MPDU frame. Contrarily, in some other implementations, see FIGS. 8-10, the MPDU frames intended for one or more of the legacy devices (e.g., the MPDU frame 705c, 805c, 905c, 1005c, intended for legacy STA 106d) are inserted after the MPDU frames intended for one or more of the non-legacy devices (e.g., the MPDU frames 705a-705b, 805a-805b, 905a-905c, 1005a-1005c intended for the non-legacy STAs 106a-106b, respectively) in the A-MPDU frame.

Block 1104 includes inserting a value that is not defined for the second device into a media access control (MAC) header field of the first MPDU frame intended for the first device or the second MPDU frame intended for the second device. For example, as previously described in connection with FIG. 7, a value may be inserted into the reserved field 414a of the delimiter field 410a of at least the first MPDU frame 705a, intended for the legacy STA 106d. In some implementations of FIG. 7, the receiver address 530 in the MAC header 502 of at least the first MPDU frame 705a may include a broadcast address value, which may not be defined for at least the legacy STAs 106d-106f.

As previously described in connection with FIG. 8, a modified FCS sequence not correctly decodable by the legacy STAs 106d-106f may be inserted into the FCS field 560 of at least the first and second MPDU frames 805a, 805b, intended for the non-legacy STAs 106a, 106b, respectively.

As previously described in connection with FIG. 9, a broadcast address that is not correctly decodable by the legacy STAs 106d-106f may be inserted into the receiver address 530 of at least the first and second MPDU frames 905a, 905b, intended for the non-legacy STAs 106a, 106b, respectively.

As previously described in connection with FIG. 10, a value indicating a new type of frame may be inserted into the frame control field 510 of at least the first and second MPDU frames 1005a, 1005b, which may be control or management frames intended for the non-legacy STAs 106a, 106b, respectively. The value indicating the new type of frame may be defined for the non-legacy STAs 106a-106c but not the legacy STAs 106d-106f of FIG. 1.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or, communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example; if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, “means for generating an aggregated media access control protocol data unit,” “means for inserting a value that is not defined for the second device into a media access control (MAC) header field,” “means for inserting the first MPDU frame intended for the first device before the second MPDU frame intended for the second device in the A-MPDU frame,” “means for inserting the first MPDU frame intended for the first device after the second MPDU frame intended for the second device in the A-MPDU frame,” and “means for modifying a value of one or more bits of a frame check sequence” may comprise the aggregation module 224 previously described in connection with FIGS. 1 and 2.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of wireless communication, comprising:
generating, by an apparatus, an aggregated media access control protocol data unit (A-MPDU) frame comprising a plurality of media access control protocol data unit (MPDU) frames, wherein a first MPDU frame of the plurality of MPDU frames is intended for at least a first device of a first type and a second MPDU frame of the plurality of MPDU frames is intended for at least a second device of a second type; and
inserting a value that is not defined for the second device into a media access control (MAC) header field of the first MPDU frame intended for the first device or the second MPDU frame intended for the second device.

2. The method of claim 1, wherein the first MPDU frame intended for the first device is inserted before the second MPDU frame intended for the second device in the A-MPDU frame.

3. The method of claim 1, wherein the first MPDU frame intended for the first device is inserted after the second MPDU frame intended for the second device in the A-MPDU frame.

4. The method of claim 1, wherein the MAC header field is a reserved field in a delimiter field of the second MPDU frame intended for the second device.

5. The method of claim 1, wherein the MAC header field is an address field and the value comprises a broadcast address associated with at least the first device.

6. The method of claim 1, wherein the MAC header field is a frame check sequence field of the first MPDU frame intended for the first device; and wherein inserting the value that is not defined for the second device further comprises modifying a value of one or more bits of a frame check sequence that is defined for the second device to generate the value that is not defined for the second device.

7. The method of claim 1, wherein the MAC header field is a frame control field of the first MPDU frame intended for the first device and wherein the value indicates a type of MPDU frame that is not defined for the second device.

8. The method of claim 1, wherein the first device is configured to communicate according to at least a first wireless communication protocol and the second device is configured to communicate according to at least a second wireless communication protocol and not the first wireless communication protocol.

9. An apparatus for wireless communication, comprising:
a processor configured to:
generate an aggregated media access control protocol data unit (A-MPDU) frame comprising a plurality of media access control protocol data unit (MPDU) frames, wherein a first MPDU frame of the plurality of MPDU frames is intended for at least a first device of a first type and a second MPDU frame of the plurality of MPDU frames is intended for at least a second device of a second type;
insert a value that is not defined for the second device into a media access control (MAC) header field of the first MPDU frame intended for the first device or the second MPDU frame intended for the second device; and
a transmitter configured to transmit the A-MPDU frame.

10. The apparatus of claim 9, wherein the processor is configured to insert the first MPDU frame intended for the first device before the second MPDU frame intended for the second device in the A-MPDU frame.

11. The apparatus of claim 9, wherein the processor is configured to insert the first MPDU frame intended for the first device after the second MPDU frame intended for the second device in the A-MPDU frame.

12. The apparatus of claim 9, wherein the MAC header field is a reserved field in a delimiter field of the second MPDU frame intended for the second device.

13. The apparatus of claim 9, wherein the MAC header field is an address field, the value comprising a broadcast address associated with at least the first device.

14. The apparatus of claim 9, wherein the MAC header field is a frame check sequence field of the first MPDU frame intended for the first device and the processor is further configured to modify a value of one or more bits of a frame check sequence that is defined for the second device to generate the value that is not defined for the second device.

15. The apparatus of claim 9, wherein the MAC header field is a frame control field of the first MPDU frame intended for the first device, the value indicating a type of MPDU frame that is not defined for the second device.

16. A non-transitory computer-readable medium comprising code that, when executed, causes an apparatus to:
generate an aggregated media access control protocol data unit (A-MPDU) frame comprising a plurality of media access control protocol data unit (MPDU) frames, wherein a first MPDU frame of the plurality of MPDU frames is intended for at least a first device of a first type and a second MPDU frame of the plurality of MPDU frames is intended for at least a second device of a second type; and
insert a value that is not defined for the second device into a media access control (MAC) header field of the first MPDU frame intended for the first device or the second MPDU frame intended for the second device.

17. The non-transitory computer-readable medium of claim 16, wherein the code, when executed, causes the apparatus to insert the first MPDU frame intended for the first device before the second MPDU frame intended for the second device in the A-MPDU frame.

18. The non-transitory computer-readable medium of claim 16, wherein the code, when executed, causes the apparatus to insert the first MPDU frame intended for the first device after the second MPDU frame intended for the second device in the A-MPDU frame.

19. The non-transitory computer-readable medium of claim 16, wherein the MAC header field is a reserved field in a delimiter field of the second MPDU frame intended for the second device.

20. The non-transitory computer-readable medium of claim 16, wherein the MAC header field is an address field, the value comprising a broadcast address associated with at least the first device.

21. The non-transitory computer-readable medium of claim 16, wherein the code, when executed, causes the apparatus to modify a value of one or more bits of a frame check sequence that is defined for the second device to generate the value that is not defined for the second device, and wherein the MAC header field is a frame check sequence field of the first MPDU frame intended for the first device.

22. The non-transitory computer-readable medium of claim 16, wherein the MAC header field is a frame control field of the first MPDU frame intended for the first device, and the value indicates a type of MPDU frame that is not defined for the second device.

23. The non-transitory computer-readable medium of claim 16, wherein the first device is configured to communicate according to at least a first wireless communication protocol and the second device is configured to communicate according to at least a second wireless communication protocol and not the first wireless communication protocol.

24. An apparatus for wireless communication, comprising:
means for generating an aggregated media access control protocol data unit (A-MPDU) frame comprising a plurality of media access control protocol data unit (MPDU) frames, wherein a first MPDU frame of the plurality of MPDU frames is intended for at least a first device of a first type and a second MPDU frame of the plurality of MPDU frames is intended for at least a second device of a second type;
means for inserting a value that is not defined for the second device into a media access control (MAC) header field of the first MPDU frame intended for the first device or the second MPDU frame intended for the second device; and
means for transmitting the A-MPDU frame.

25. The apparatus of claim 24, further comprising means for inserting the first MPDU frame intended for the first device before the second MPDU frame intended for the second device in the A-MPDU frame.

26. The apparatus of claim 24, further comprising means for inserting the first MPDU frame intended for the first device after the second MPDU frame intended for the second device in the A-MPDU frame.

27. The apparatus of claim 24, wherein the MAC header field is a reserved field in a delimiter field of the second MPDU frame intended for the second device.

28. The apparatus of claim 24, wherein the MAC header field is an address field, and the value comprises a broadcast address associated with at least the first device.

29. The apparatus of claim 24, wherein the MAC header field is a frame check sequence field of the first MPDU frame intended for the first device, the apparatus further comprising means for modifying a value of one or more bits of a frame check sequence that is defined for the second device to generate the value that is not defined for the second device.

30. The apparatus of claim 24, wherein the MAC header field is a frame control field of the first MPDU frame intended for the first device, the value indicating a type of MPDU frame that is not defined for the second device.
